(19) United States
(12) Patent Application Publication
(10) Pub. No.: US 2023/0182554 A1
(43) Pub. Date: Jun. 15, 2023

(54) FRAMELESS DOOR FOR VEHICLE AND METHOD FOR MANUFACTURING THEREOF

(71) Applicants: Hyundai Motor Company, Seoul (KR); Kia Corporation, Seoul (KR); HWASEUNG R&A CO., LTD, Yangsan (KR)

(72) Inventors: Hyeong Geun Jo, Suwon (KR); You Chan Park, Ansan (KR); Young Uk Yun, Suwon (KR); Hoo Sang Park, Hwaseong (KR); Jin Hyung Bae, Yangsan (KR); Ji Yun Cha, Yangsan (KR)

(21) Appl. No.: 17/968,116

(22) Filed: Oct. 18, 2022

(30) Foreign Application Priority Data
Dec. 15, 2021 (KR) 10-2021-0179816

(51) Int. Cl. B60J 10/77; B60J 10/76

(52) U.S. Cl. CPC B60J 10/77; B60J 10/76

(57) ABSTRACT

A frameless door for a vehicle and a method for manufacturing the same are provided. The frameless door includes a fixed glass coupled to a door frame of a vehicle, an elastic member mounted to enclose an upper edge of the fixed glass, a glass run configured to guide upward and downward movements of a moving glass with respect to the fixed glass, and a division channel accommodating the glass run therein while the glass run and the elastic member are mounted to the fixed glass, and configured to slidingly move in a vertical direction to fix a location of the fixed glass to the door frame.

### CROSS REFERENCE TO RELATED APPLICATION

The present application claims under 35 U.S.C. § 119(a) the benefit of Korean Patent Application No. 10-2021-0179816, filed Dec. 15, 2021, the entire contents of which is incorporated herein for all purposes by this reference.

### Field of the Disclosure

Embodiment of the present disclosure relate generally to a frameless door for a vehicle and a method for manufacturing the same. More particularly, the present disclosure relates to a frameless door for a vehicle and a method for manufacturing the same, wherein the frameless door has an integrated structure without a step difference between a moving glass and a fixed glass, and is configured to prevent water from flowing into the vehicle through periphery of the fixed glass in a situation such as rain or car washing.

### Description of the Related Art

Generally, a body of a vehicle is equipped with a door that is rotatably opened and closed by means of a hinge for an occupant to board the vehicle. The door includes a door glass that selectively opens the indoor space by moving upward and downward by a door regulator.

The type of the door may be divided into a frame-structure door in which a frame supports the door glass and a frameless door having a structure in which the door glass raised and lowered is supported by a panel provided in the vehicle body without using a frame.

More particularly, in the frameless door, the door glass has a structure in which the door glass is brought into contact with a door weather strip in sealing of the door, so that airtightness between the door and the vehicle part is maintained.

Meanwhile, in a vehicle with the frameless door, a fixed glass part may be securely mounted to not only a rear door, but also a front door. The fixed glass is integrally mounted to one portion of a division channel.

However, in a case of vehicles equipped with the frameless door that are recently released, a futuristic design is realized by eliminating a step difference between the fixed glass and the door glass and making the fixed glass and door glass look like one part. However, in case of rain, car washing, etc., there is a problem in that water flows into the vehicle room through the periphery of the fixed glass, more specifically, through a gap between the door glass and the fixed glass.

### SUMMARY OF THE DISCLOSURE

In one aspect, a frameless door for a vehicle is provided and a method for manufacturing the same.

In an aspect, a frameless door for a vehicle, the frameless door comprising: (a) a fixed glass configured to be coupled to a door frame of a vehicle; (b) an elastic member mounted to the fixed glass to enclose an upper edge of the fixed glass; (c) a glass run configured to guide upward and downward movements of a moving glass with respect to the fixed glass; and (d) a division channel accommodating the glass run therein while the glass run and the elastic member are mounted to the fixed glass, and configured to slidingly move in a vertical direction to fix a location of the fixed glass to the door frame.

In a further aspect, the frameless door includes a fixed glass that is finished by steps that may include coupling a division channel to a rail member coupled to the fixed glass and a glass run by a rail coupling manner while thermoplastic elastomer (TPE) has been molded to an entire area of an upper edge of the fixed glass corresponding to a region where the fixed glass is brought into close contact with a body-side weatherstrip provided in a vehicle body, so that when the door is closed, uniform tightness is realized at an upper portion of the fixed glass where the body-side weatherstrip and the fixed glass face each other.

In one preferred embodiment of the present disclosure, there is provided a frameless door for a vehicle, the frameless door including: a fixed glass coupled to a door frame of a vehicle; an elastic member mounted to the fixed glass to enclose an upper edge of the fixed glass; a glass run configured to guide upward and downward movements of a moving glass with respect to the fixed glass; and a division channel accommodating the glass run therein while the glass run and the elastic member are mounted to the fixed glass, and configured to slidingly move in a vertical direction to fix a location of the fixed glass to the door frame.

The frameless door may include: a rail member vertically coupled to the fixed glass at a first side of the fixed glass, wherein the division channel may be coupled to the rail member in a rail coupling manner together with the glass run, and is configured to be mounted to the fixed glass by sliding movement.

The elastic member may have a length corresponding to the upper edge of the fixed glass, and have a longitudinally flat sealing surface.

The elastic member may be configured to be coupled to the fixed glass at the upper edge of the fixed glass in a form of enclosing a first corner portion of the fixed glass, and may have an inclined form gradually downward to a second corner portion of the fixed glass.

A method for manufacturing a frameless door for a vehicle may include: bonding a rail member, wherein the rail member may be bonded in a vertical direction to one portion of a fixed glass coupled to a door frame of a vehicle; molding a glass run, wherein the glass run configured to guide upward and downward movements of a moving glass with respect to the fixed glass may be molded; modularizing, wherein the elastic member may be mounted to the fixed glass to enclose an upper edge of the fixed glass and the glass run is modularized by being fixed adj acent to the rail member; and fixing a location of the fixed glass, wherein the division channel may slidingly move in the vertical direction while accommodating the rail member and the glass run therein and may fixe the location of the fixed glass to the door frame.

The modularizing may be performed by molding and mounting the elastic member with a length corresponding to the upper edge of the fixed glass, and the elastic member may have a longitudinally flat sealing surface.

The modularizing may be performed by molding the elastic member such that the elastic member may enclose from the upper edge of the fixed glass to a part of a first corner portion of the fixed glass, and the elastic member may have an inclined form gradually downward to a second corner portion of the fixed glass.

In the present disclosure, the frameless door including the fixed glass is finished by rail-coupling the division channel to the rail member coupled to the fixed glass and the separate glass run while thermoplastic elastomer (TPE) is molded on an entire area of the upper edge of the fixed glass corresponding to an area in close contact with the body-side weatherstrip provided in the vehicle body. Therefore, when the door is closed, uniform tightness is realized at the upper edge of the fixed glass where the body-side weatherstrip and the fixed glass face each other.

Accordingly, the present disclosure is configured to prevent water from flowing into the vehicle through periphery of the fixed glass in a situation such that rain or car washing, and to implement zero step difference between the fixed glass and the moving glass by the structure of the glass run and the division channel as in the conventional door, thereby there is an effect of satisfying the design element for the frameless door.

In another embodiment, vehicles are provided that comprise an apparatus as disclosed herein. In one aspect, a vehicle is provided that comprises: a frameless door for a vehicle, the frameless door comprising: (a) a fixed glass coupled to a door frame of the vehicle; (b) an elastic member mounted to the fixed glass to enclose an upper edge of the fixed glass; (c) a glass run configured to guide upward and downward movements of a moving glass with respect to the fixed glass; and (d) a division channel accommodating the glass run therein while the glass run and the elastic member are mounted to the fixed glass, and configured to slidingly move in a vertical direction to fix a location of the fixed glass to the door frame. Additional aspects are disclosed infra.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view schematically showing a structure of a frameless door for a vehicle according to the embodiment of the present disclosure.

FIG. 2 is a sectional view showing the frameless door for a vehicle according to the embodiment of the present disclosure, the view being taken along line A-A in FIG. 1.

FIG. 3 is a view showing an elastic member of the frameless door for a vehicle according to the embodiment of the present disclosure.

FIG. 4 is a sectional view showing the frameless door for a vehicle according to the embodiment of the present disclosure, the view being taken along line A-A in FIG. 3.

FIG. 5 is a view showing an elastic member of the frameless door for a vehicle according to the embodiment of the present disclosure.

FIG. 6 is a sectional view showing the frameless door for a vehicle according to the embodiment of the present disclosure, the view being taken along line A-A in FIG. 5.

FIG. 7 is a view showing an elastic member of the frameless door for a vehicle according to another embodiment of the present disclosure.

FIGS. 8 to 12 are views showing a method for manufacturing a frameless door for a vehicle according to another embodiment of the present disclosure in order.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Hereinbelow, an exemplary embodiment of the present disclosure will be described in detail with reference to the accompanying drawings

The features and advantages of the present disclosure and method for achieving the features and advantages will be more clearly understood from the following detailed description when taken in conjunction with the accompanying drawings

However, the present disclosure is not limited to the following embodiments, is implemented as various forms. The embodiments of the present disclosure are presented to make complete disclosure of the present disclosure and help those who are ordinarily skilled in the art best understand the disclosure. In addition, the scope of the present disclosure is defined only by the accompanying claims and their equivalents if appropriate.

Furthermore, in the following description of the present disclosure, detailed descriptions of known functions and configurations which are deemed to make the gist of the present disclosure obscure will be omitted.

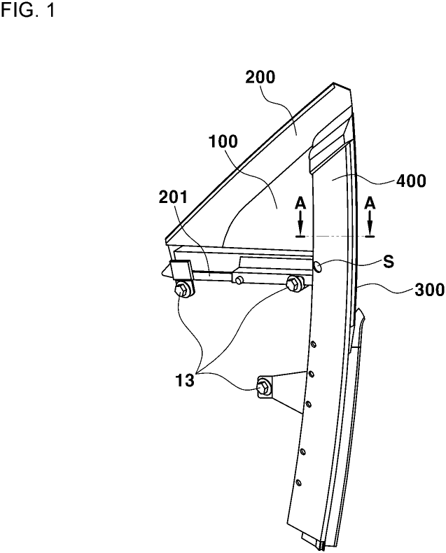

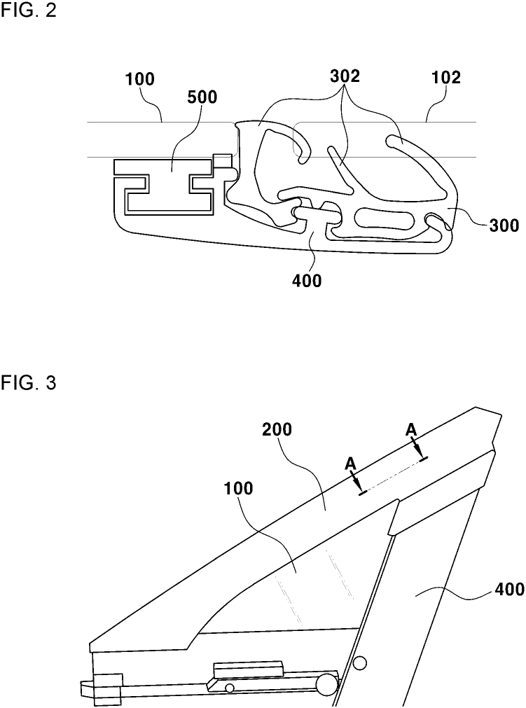

FIG. 1 is a view schematically showing a structure of a frameless door for a vehicle according to the embodiment of the present disclosure. FIG. 2 is a sectional view showing the frameless door for a vehicle according to the embodiment of the present disclosure, the view being taken along line A-A in FIG. 1.

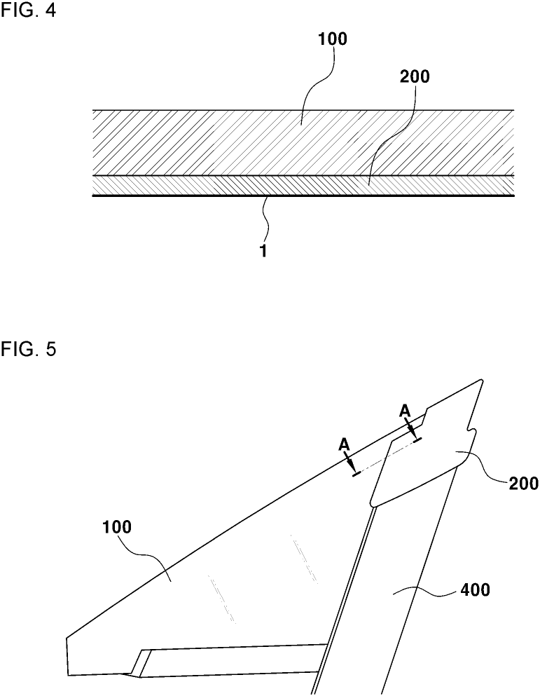

FIG. 3 is a view showing an elastic member of the frameless door for a vehicle according to the embodiment of the present disclosure. FIG. 4 is a sectional view showing the frameless door for a vehicle according to the embodiment of the present disclosure, the view being taken along line A-A in FIG. 3.

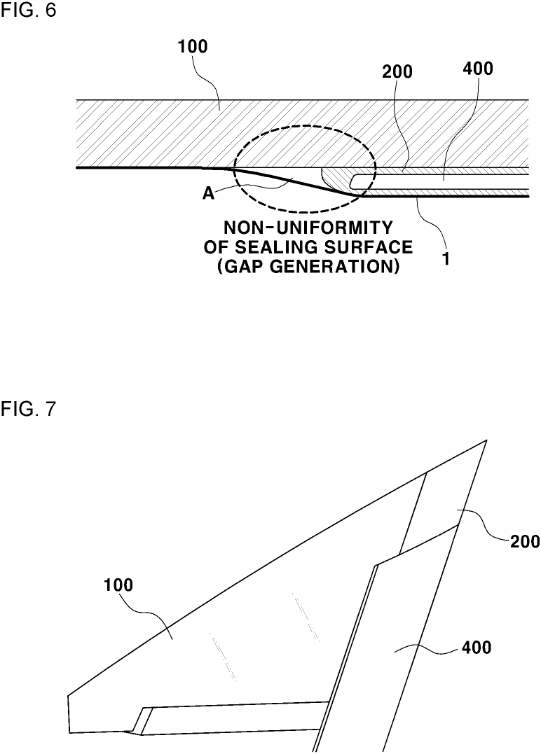

FIG. 5 is a view showing an elastic member of the frameless door for a vehicle according to the embodiment of the present disclosure. FIG. 6 is a sectional view showing the frameless door for a vehicle according to the embodiment of the present disclosure, the view being taken along line A-A in FIG. 5. FIG. 7 is a view showing an elastic member of the frameless door for a vehicle according to another embodiment of the present disclosure.

As shown in FIG. 1, according to the embodiment of the present disclosure, the frameless door for a vehicle may include a fixed glass 100, an elastic member 200, a glass run 300, and a division channel 400.

Normally, a vehicle may be equipped with a door frame constituting a door, and a moving glass 102 and a window regulator motor (not shown) provided to move the moving glass 102 to reciprocate in a vertical direction are provided and coupled to the inner space of the door frame,.

Furthermore, as described above, at a front portion of the door frame with the moving glass 102, i.e., at an A pillar, the fixed glass 100 may be securely coupled. The fixed glass 100 may be fixed to be immobilized different from the moving glass 102.

The elastic member 200 may be made of a material such as rubber, etc., and may be mounted to enclose an upper edge of the fixed glass 100.

The elastic member 200 may be preferably made of thermoplastic elastomer (TPE) that has excellent properties such as resilience and shock absorption for a state where the fixed glass 100 and a body-side weatherstrip are brought into close contact with each other in closing of the door frame.

The elastic member 200 may be formed to have a length corresponding to an upper edge of the fixed glass 100. When the fixed glass is brought into close contact with the body-side weatherstrip, the elastic member 200 is formed to have a flat sealing surface 1 in a longitudinal direction thereof as shown in FIG. 4.

Conventionally, the division channel 400 may be coupled to one portion of the fixed glass 100, and the elastic member 200 is extrusion-molded from TPE rubber and coupled to the division channel 400, and as shown in FIG. 5, a part of the elastic member 200 is exposed with a step difference from the fixed glass 100 at the first portion of the fixed glass 100. However, in the above case, as shown in FIG. 6, when the body-side weatherstrip and the elastic member are brought into close contact with each other, a predetermined space A is generated in the sealing surface 1 by the step difference between the fixed glass 100 and the elastic member 200, and thus the space A acts as a cause of a non-uniformity problem of the sealing surface 1.

Therefore, the elastic member 200 according to the embodiment of the present disclosure may be formed to have the length corresponding to a front surface of the fixed glass 100, more particularly, to the upper edge of the front surface of the fixed glass, so that the above problem can be solved.

In other words, the elastic member 200 may be coupled to the fixed glass 100 to entirely enclose the front surface of the fixed glass 100 as shown in FIGS. 3 and 4. Therefore, compared to the conventional structure, the elastic member of the present disclosure provides the uniform sealing surface 1, and thus a step difference may not be generated when the fixed glass 100 is brought into close contact with the body-side weatherstrip by closing the door frame. As a result, the sealing surface 1 acts uniformly, so that the problem in that water flows into the indoor space of the vehicle in a situation such as rain or car washing.

Herein, as shown in FIG. 7, the elastic member 200 may be configured to be coupled to the fixed glass 100 to enclose a first corner portion of the fixed glass 100 at the upper edge of the fixed glass 100. The elastic member 200 may be formed to be gradually inclined downward to a second corner portion of the fixed glass 100.

As described above, when the elastic member 200 has the inclined form gradually downward, the sealing surface 1 between the fixed glass 100 and the elastic member 200 may be formed in the sealing surface 1 approximately close to flat.

Accordingly, when the door frame is opened, an area where the elastic member 200 is exposed outward may be minimized, and thus the exterior of the vehicle can be made neat. When the door frame is closed, in tightness between the fixed glass 100 and the body-side weather strip, generation of the space A into which water flows into the indoor space of the vehicle may be minimized.

Meanwhile, the glass run 300 may be provided to guide upward and downward movements of the moving glass 102 with respect to the fixed glass 100. More preferably, the glass run 300 is made of ethylene-propylene diene monomer (EPDM) material, and has a plurality of inner lips 302 supporting the moving glass 102 for watertightness (referring to FIG. 2).

Furthermore, the division channel 400 may be configured to support an upward movement location of the moving glass 102 when the moving glass 102 is raised, and may be configured to secure watertightness and indoor soundproof performance. While the glass run 300 and the elastic member 200 are molded and mounted to the fixed glass 100, the division channel 400 is configured to accommodate the glass run 300 therein and slidingly move vertically to fix the fixed glass 100 to the door frame.

Therefore, the division channel 400 may stably fix the location of the glass run 300, and as a result, the division channel 400 prevents the step difference between the fixed glass 100 and the moving glass 102 from being generated outside the vehicle, thereby satisfying the design element for the frameless door.

The division channel 400 may be coupled to the fixed glass 100 by being pushed in the vertical direction, i.e., a bottom to top direction at one portion of the fixed glass 100, while the glass run 300 and a rail member 500 have been located in the division channel 400.

In other words, the H-shaped rail member 500 may be coupled to the one portion of the fixed glass 100 in the vertical direction (referring to FIG. 2), and while the fixed glass 100, the rail member 500, a plurality of brackets B, and the glass run 300 are integrally placed on an injection molding, a plurality of elastic members 200 and 201 may be molded to the fixed glass 100 and may be manufactured as a fixed glass product to be mounted to the door frame. Herein, the division channel 400 may push the glass run 300 while the glass run 300 is inserted in the division channel 400, and the rail member 500 may also be inserted into at a predetermined location of the division channel 400, thereby being mounted to the fixed glass product in a rail coupling manner.

Conventionally, after the division channel 400 is coupled to the fixed glass 100, in a state where the glass run 300 has been extrusion-molded, the elastic member 200 may be insertion-coupled to the fixed glass, and then a fixed glass product may be complete. Therefore, a step difference is generated between the elastic member 200 and the fixed glass 100 that are insertion-coupled to each other, thereby causing an ununiform sealing surface 1 (referring to FIG. 6).

However, in the embodiment, the glass run 300 may be extrusion-molded, and in a state where the elastic member 200 is mounted to enclose the entire upper edge of the fixed glass 100, the division channel 400 may be mounted to the fixed glass 100 in the rail coupling manner by using the rail member 500. Therefore, when fixing and mounting by a separate screw S are complete, only the elastic member 200 is located at the upper edge of the fixed glass 100, and the sealing surface 1 formed on the fixed glass 100 is formed uniformly by the elastic member 200 (referring to FIG. 4). Therefore, it is possible to prevent a problem in that water flows into the vehicle in a situation such as rain or car washing.

In a case of the fixed glass product manufactured as described above, the fixed glass product has been described as being limited to be mounted to a front door of the vehicle, but the fixed glass product may be equally mounted to a rear door of a vehicle.

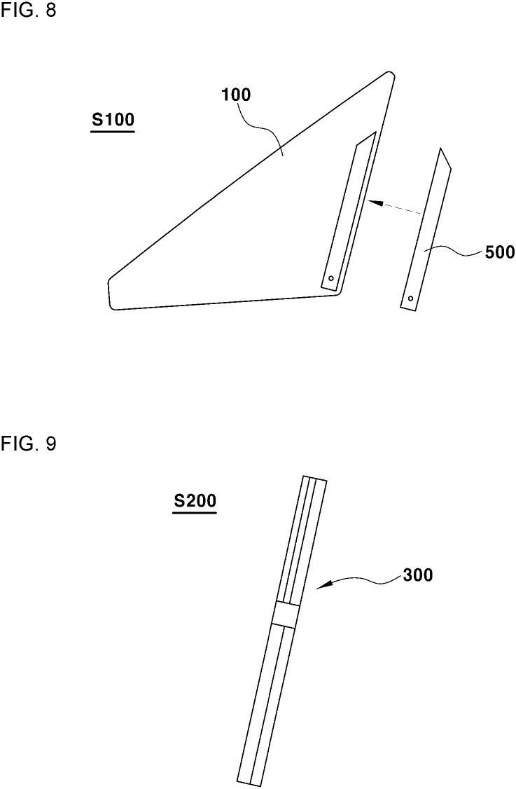

Hereinbelow, FIGS. 8 to 12 are views showing a method for manufacturing a frameless door for a vehicle according to another embodiment of the present disclosure in order.

As shown in FIGS. 8 to 12, a method for manufacturing the flameless door for a vehicle according to the embodiment will be successively described as follows.

First, as shown in FIG. 8, the rail member 500 having a predetermined length in the vertical direction may be bonded to one portion of the fixed glass 100 to be coupled to the door frame of a vehicle at S100.

Then, as shown in FIG. 9, the glass run 300 may be molded at S200. The glass run 300 has a predetermined length to guide upward and downward movements of the moving glass 102 with respect to the fixed glass 100.

The glass run 300 may be preferably made of EPDM material, and may be configured such that the plurality of inner lips 302 longitudinally support the moving glass 102 for watertightness (referring to FIG. 2).

Next, in a state where the rail member 500, a plurality of brackets B and the molded glass run 300 are integrally placed to an injection mold with respect to the fixed glass 100, a plurality of elastic members 200 and 201 may be molded at the fixed glass 100 at high temperature and high pressure. Therefore, as shown in FIG. 10, modularization of the fixed glass product for mounting the fixed glass to the door frame in a state where the elastic member 200 encloses the upper edge of the fixed glass 100 including a corner portion is performed at S300.

Herein, the elastic member 200 may be coupled to the fixed glass 100 to enclose the entire area of the upper edge of the fixed glass 100 so that generation of the uniform sealing surface 1 is possible. However, the elastic member 200 may be coupled to the fixed glass 100 to partially enclose a first corner portion at the upper edge of the fixed glass 100 (referring to FIG. 7). Herein, the elastic member 200 may be formed in an inclined shape gradually downward to a second corner portion of the fixed glass.

As described above, when the elastic member 200 has the inclined form gradually downward, the sealing surface 1 between the fixed glass 100 and the elastic member 200 may be formed in the sealing surface 1 approximately close to flat.

Accordingly, when the door frame is opened, an area where the elastic member 200 may be exposed outward may be minimized, and thus the exterior of the vehicle can be made neat. When the door frame is closed, in tightness between the fixed glass 100 and the body-side weather strip, generation of the space A into which water flows into the indoor space of the vehicle may be minimized.

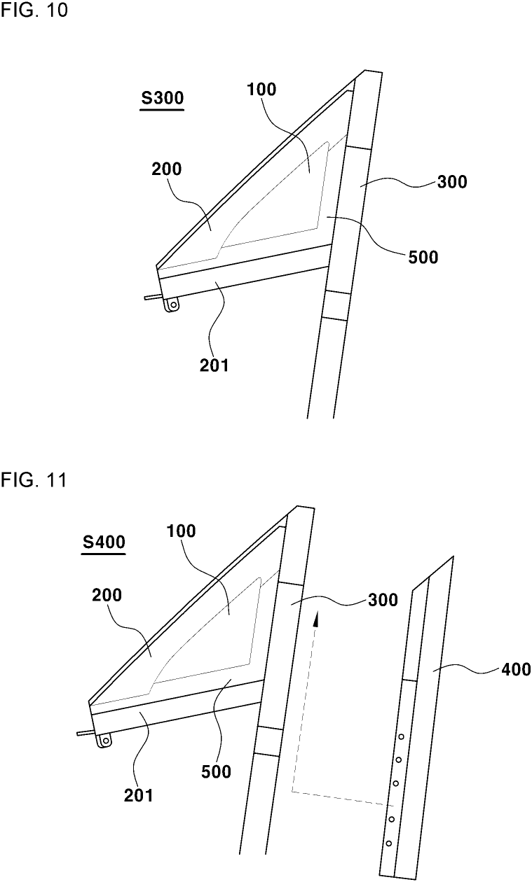

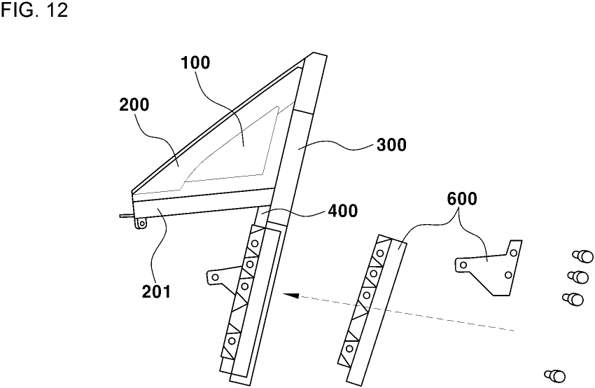

Meanwhile, as described above, when the fixed glass product is modularized at S300, as shown in FIG. 11, the division channel 400 may slidingly move in the vertical direction while accommodating the rail member 500 and the glass run 300 therein and may be coupled to the fixed glass at S400. Then, as shown in FIG. 12, a plurality of coupling members 600 provided to couple the fixed glass to the door frame is mounted to the division channel 400, and finally the fixed glass product is finished.

Conventionally, after the division channel 400 is coupled to the fixed glass 100, in a state where the glass run 300 has been extrusion-molded, the elastic member 200 may be insertion-coupled to the fixed glass, and then a fixed glass product may be complete. Therefore, a step difference is generated between the elastic member 200 and the fixed glass 100 that are insertion-coupled to each other, thereby causing an ununiform sealing surface 1 (referring to FIG. 6).

However, in the embodiment, since the glass run 300 is extrusion-molded, and the division channel 400 is mounted to the fixed glass 100 in the rail coupling manner by using the rail member 500 while the elastic member 200 has been mounted to enclose the entire area of the upper edge of the fixed glass 100 at S300, only the elastic member 200 may be located at the upper edge of the fixed glass 100 when the mounting is complete.

Accordingly, the sealing surface 1 of the fixed glass 100 in close contact with the body-side weatherstrip when the door frame is closed may be formed uniformly by the elastic member 200 mounted as described above (referring to FIG. 4). As a result, it is possible to prevent a problem in that water flows into the vehicle through the space generated between the sealing surface 1 and the fixed glass 100 in a situation such as rain or car washing.

In the present disclosure, the frameless door including the fixed glass may be finished by rail-coupling the division channel to the rail member coupled to the fixed glass and the separate glass run while thermoplastic elastomer (TPE) has been molded on an entire area of the upper edge of the fixed glass corresponding to an area in close contact with the body-side weatherstrip provided in the vehicle body. Therefore, when the door is closed, uniform tightness is realized at the upper edge of the fixed glass where the body-side weatherstrip and the fixed glass face each other.

Accordingly, the present disclosure may be configured to prevent water from flowing into the vehicle through periphery of the fixed glass in a situation such that rain or car washing, and to implement zero step difference between the fixed glass and the moving glass by the structure of the glass run and the division channel as in the conventional door, thereby there is an effect of satisfying the design element for the frameless door.

Although the preferred embodiment(s) of the present disclosure has been disclosed for illustrative purposes, those skilled in the art will appreciate that various modifications, additions and substitutions are possible, without departing from the scope and spirit of the disclosure as disclosed in the accompanying claims, and it will be appreciated that all or part of the embodiment(s) described above may optionally be combined to constitute the present disclosure. Therefore, the technical protection scope of the present disclosure should be determined by the technical idea of the accompanying claims.

What is claimed is:

1. A frameless door for a vehicle, the frameless door comprising:
a fixed glass configured to be coupled to a door frame of a vehicle;
an elastic member mounted to the fixed glass to enclose an upper edge of the fixed glass;
a glass run configured to guide upward and downward movements of a moving glass with respect to the fixed glass; and
a division channel accommodating the glass run therein while the glass run and the elastic member are mounted to the fixed glass, and configured to slidingly move in a vertical direction to fix a location of the fixed glass to the door frame.

2. The frameless door of claim 1, further comprising:
a rail member vertically coupled to the fixed glass at a first side of the fixed glass,
wherein the division channel is coupled to the rail member in a rail coupling manner together with the glass run, and is configured to be mounted to the fixed glass by sliding movement.

3. The frameless door of claim 1, wherein the elastic member has a length corresponding to the upper edge of the fixed glass, and has a longitudinally flat sealing surface.

4. The frameless door of claim 1, wherein the elastic member is configured to be coupled to the fixed glass at the upper edge of the fixed glass in a form of enclosing a first corner portion of the fixed glass, and has an inclined form gradually downward to a second corner portion of the fixed glass.

5. The frameless door of claim 1, wherein the elastic member is made of thermoplastic elastomer (TPE).

6. The frameless door of claim 1, wherein the glass run is made of ethylene-propylene diene monomer (EPDM) material.

7. The frameless door of claim 1, wherein the glass run has a plurality of inner lips supporting the moving glass for watertightness.

8. A method for manufacturing a frameless door for a vehicle, the method comprising:
bonding a rail member, wherein the rail member is bonded in a vertical direction at one portion of a fixed glass coupled to a door frame of a vehicle;
molding a glass run, wherein the glass run configured to guide upward and downward movements of a moving glass with respect to the fixed glass is molded;
modularizing, wherein the elastic member is mounted to the fixed glass to enclose an upper edge of the fixed glass and the glass run is modularized by being fixed adjacent to the rail member; and
fixing a location of the fixed glass, wherein the division channel slidingly moves in the vertical direction while accommodating the rail member and the glass run therein and fixes the location of the fixed glass to the door frame.

9. The method of claim 8, wherein the modularizing is performed by molding and mounting the elastic member with a length corresponding to the upper edge of the fixed glass, and the elastic member has a longitudinally flat sealing surface.

10. The method of claim 8, wherein the modularizing is performed by molding the elastic member such that the elastic member encloses from the upper edge of the fixed glass to a part of a first corner portion of the fixed glass, and the elastic member has an inclined form gradually downward to a second corner portion of the fixed glass.

11. A vehicle comprising the frameless door of claim 1.
